(19) United States
(12) Patent Application Publication
(10) Pub. No.: US 2006/0152159 A1
(43) Pub. Date: Jul. 13, 2006

(54) Plasma display panel

(76) Inventor: Hun-Suk Yoo, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/328,706

(22) Filed: Jan. 10, 2006

(30) Foreign Application Priority Data
Jan. 12, 2005 (KR) 10-2005-0002910

(51) Int. Cl. H01J 17/49

(52) U.S. Cl. 313/587

(57) ABSTRACT

A plasma display panel (PDP) is disclosed. In one embodiment, the PDP includes: i) a front substrate and a rear substrate facing the front substrate, ii) X display electrodes and Y display electrodes formed on an inner surface of the front substrate, iii) first igniter electrodes and second igniter electrodes formed between the X and Y display electrodes, iv) a first dielectric layer formed on the inner surface of the front substrate for covering the X and Y display electrodes, and the first and second igniter electrodes, v) first floating electrodes and second floating electrodes formed on an inner surface of the first dielectric layer in a length direction of the X and Y display electrodes, and vi) a second dielectric layer formed on the inner surface of the first dielectric layer for covering the floating electrodes. According to one embodiment of the present invention, the light emission efficiency of the plasma display panel can be improved.

### CROSS-REFERENCE TO RELATED PATENT APPLICATIONS

This application claims the benefit of Korean Patent Application No. 10-2005-0002910, filed on Jan. 12, 2005, in the Korean Intellectual Property Office, the disclosure of which is incorporated herein in its entirety by reference.

### BACKGROUND OF THE INVENTION

1. Field of the Invention

The present invention relates to a plasma display panel, and more particularly, to a plasma display panel which reduces a discharge voltage and improves light emission efficiency with the use of additional electrodes such as igniter electrodes and/or floating electrodes.

2. Description of the Related Technology

A plasma display panel (PDP) apparatus can provide enhanced image quality, a thin profile, light weight, and a wide viewing angle in a large screen. The PDP apparatus can be fabricated in a simple way and a larger sized PDP can be easily manufactured. Therefore, PDPs are considered to be next generation flat panel display devices.

Generally, PDPs can be classified into alternating current (AC) PDPs, direct current (DC) PDPs, and hybrid PDPs according to structure and operational method. Especially, the AC and DC plasma display panels are divided into surface discharge type and facing discharge type PDPs according to discharge structures. The AC surface discharge type PDPs are mainly used nowadays.

FIG. 1 shows a conventional AC three-electrode surface discharge type PDP.

The PDP includes a front substrate 11 and a rear substrate 21 facing the front substrate 11. The front and rear substrates 11 and 21 are coupled to each other with inner structures therein, and thus, forming the PDP.

On an inner surface of the front substrate 11, sustain electrode pairs 12, each of which includes an X display electrode 13 and a Y display electrode 14 forming a discharge gap with respect to the X electrode 13. Each of the X electrode 13 and the Y electrode 14 includes a bus electrode 17. The bus electrode 17 is formed of a metal having high conductivity in order to mitigate high resistances of the X and Y electrodes 13 and 14 that are formed of a transparent electrode material such as indium tin oxide (ITO). The X and Y electrodes 13 and 14 are embedded in a front dielectric layer 15. A protective layer 16 is formed on an inner surface of the front dielectric layer 15.

On an inner surface of the rear substrate 21, address electrodes 22 are formed to cross the X and Y electrodes 13 and 14, and are embedded in a rear dielectric layer 23. Barrier ribs 24, having predetermined intervals, are formed on the rear dielectric layer 23 so as to define discharge spaces 25. Phosphor layers 26 are formed in the discharge spaces 25, and a discharge gas is filled in the discharge spaces 25.

In the PDP having the above structure, plasma formed by a discharge generates ultraviolet radiation in the discharge spaces 25. The ultraviolet radiation excites the phosphor layers 26, and the excited phosphor layers 26 emit visible light to display images.

FIG. 2 is a schematic cross-sectional view of the PDP of FIG. 1.

Referring to FIG. 2, the X and Y electrodes 13 and 14 are formed on the inner surface of the front substrate 11 and covered by the front dielectric layer 15. The address electrodes 22 are formed on the inner surface of the rear substrate 21 and covered by the rear dielectric layer 23. The PDP is driven by address discharge and sustain discharge. The address discharge occurs due to the difference between electric potentials of the address electrode 22 and the Y electrode 14, and wall charges are formed during the address discharge. The sustain discharge occurs due to the difference between the electric potentials of the X and Y electrodes 13 and 14 located in the discharge space where the wall charges are formed, and images are actually displayed as a result of the sustain discharge between the electrodes 13 and 14 over many discharge spaces.

In FIG. 2, references characters f1, f2, and f3 denote distribution of wall charges and discharge paths when the sustain discharge occurs between the display electrodes 13 and 14. The sustain discharge occurs between the discharge electrodes 13 and 14. More particularly, the sustain discharge starts between adjacent end portions of the discharge electrodes 13 and 14, is diffused to center portions of the electrodes 13 and 14, and then, reaches outer end portions of the electrodes 13 and 14 and disappears. Here, the wall charges are not evenly distributed throughout the entire space between the display electrodes 13 and 14, but locally concentrated. The discharge f1 generated between the end portions of the display electrodes 13 and 14 and the discharge f2 generated at the center portion of the electrodes 13 and 14 can occur. However, the discharge f3 at the outer end portions of the display electrodes is difficult to occur due to a shortage of wall charges. Therefore, the discharge voltage needs to be increased to provide a sufficient discharge between the sustain electrodes, resulting in reduced discharge efficiency.

### SUMMARY OF CERTAIN INVENTIVE ASPECTS

One aspect of the present invention provides a plasma display panel having an enhanced discharge structure.

Another aspect of the present invention provides a plasma display panel capable of reducing a discharge voltage, and improving discharge efficiency.

Another aspect of the present invention provides a plasma display panel including a dielectric layer of dual-layered structure having an electric field concentration portion formed on a front substrate, and an igniter electrode and a floating electrode.

Another aspect of the present invention provides a plasma display panel including: i) a front substrate and a rear substrate facing the front substrate, ii) X display electrodes and Y display electrodes formed on an inner surface of the front substrate, iii) first igniter electrodes and second igniter electrodes formed between the X and Y display electrodes, iv) a first dielectric layer formed on the inner surface of the front substrate for covering the X and Y display electrodes, and the first and second igniter electrodes, v) first floating electrodes and second floating electrodes formed on an inner surface of the first dielectric layer in a length direction of the X and Y display electrodes, vi) a second dielectric layer formed on the inner surface of the first dielectric layer for covering the floating electrodes, vii) a protective layer formed on an inner surface of the second dielectric layer, viii) address electrodes formed on an inner surface of the rear substrate to cross the X and Y display electrodes at a right angle, ix) a rear dielectric layer embedding the address electrodes,
x) barrier ribs formed on an upper surface of the rear dielectric layer to define discharge spaces, xi) phosphor layers formed in the discharge spaces, and xii) a discharge gas filled in the discharge spaces.

In one embodiment, electric field concentration portions may be formed on the second dielectric layer by making some parts of the second dielectric layer thin.

In one embodiment, the electric field concentration portions may be disposed on the center of the discharge spaces defined between the barrier ribs, at the portions corresponding to the discharge gaps between the display electrodes.

In one embodiment, the same voltage as that applied to the X display electrode may be applied to the first igniter electrode, and the same voltage as that applied to the Y display electrode may be applied to the second igniter electrode.

In one embodiment, the X display electrode may be connected to the first igniter electrode, and the Y display electrode may be connected to the second igniter electrode.

In one embodiment, the voltage may not be applied to the first and second floating electrodes.

In one embodiment, the floating electrodes may be formed on the portions corresponding to adjacent end portions of the display electrodes.

In another embodiment, the first and second floating electrodes may be disposed on both sides of the electric field concentration portion.

Another aspect of the present invention provides a plasma display panel including: i) a front substrate and a rear substrate facing the front substrate, ii) X display electrodes and Y display electrodes formed on an inner surface of the front substrate, iii) a first dielectric layer formed on the inner surface of the front substrate for covering the X and Y display electrodes, and the first and second igniter electrodes, iv) first floating electrodes and second floating electrodes formed on an inner surface of the first dielectric layer in a length direction of the X and Y display electrodes, v) a second dielectric layer formed on the inner surface of the first dielectric layer for covering the floating electrodes, wherein an electric field concentration portion is formed on the second dielectric layer by reducing the thickness of the second dielectric layer, vi) a protective layer formed on an inner surface of the second dielectric layer, vii) address electrodes formed on an inner surface of the rear substrate to cross the X and Y display electrodes at a right angle, viii) a rear dielectric layer embedding the address electrodes, ix) barrier ribs formed on an upper surface of the rear dielectric layer to define discharge spaces, x) phosphor layers formed in the discharge spaces, and xi) a discharge gas filled in the discharge spaces.

### BRIEF DESCRIPTION OF THE DRAWINGS

Embodiments of the present invention will be described with reference to the attached drawings.

FIG. 1 is an exploded perspective view of a conventional plasma display panel.

FIG. 2 is a schematic cross-sectional view of a part of the plasma display panel shown in FIG. 1.

FIG. 3 is a schematic exploded perspective view of a plasma display panel according to an embodiment of the present invention.

FIG. 4 is a schematic cross-sectional view of a part of the plasma display panel shown in FIG. 3.

FIG. 5 is a schematic cross-sectional view of a part of the plasma display panel according to another embodiment of the present invention.

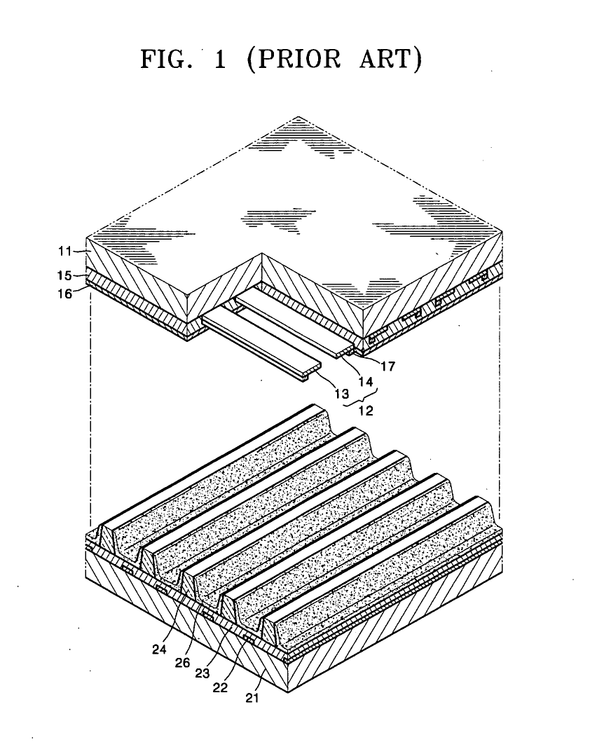

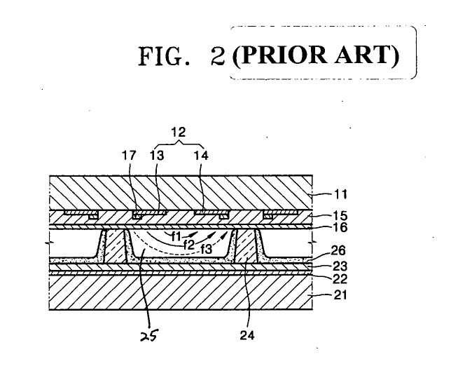

### DETAILED DESCRIPTION OF CERTAIN INVENTIVE EMBODIMENTS

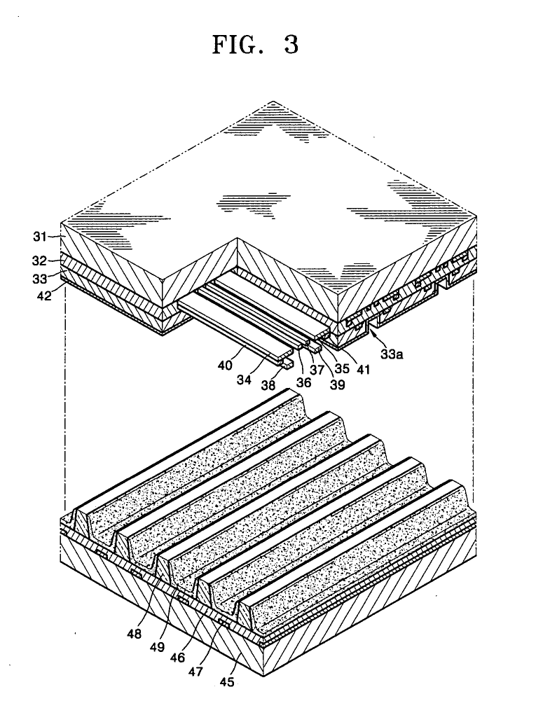

FIG. 3 is a schematic exploded perspective view of a plasma display panel (PDP) according to one embodiment of the present invention.

In one embodiment, as shown in FIG. 3, the PDP includes a front substrate 31, and a rear substrate 45 facing the front substrate 31. The front substrate 31 and the rear substrate 45 are coupled to each other to form the PDP as shown in FIG. 3.

X display electrodes 34 and Y display electrodes 35 are formed on an inner surface of the front substrate 31. Discharge gaps are formed between the display electrodes 34 and 35, and the display electrodes 34 and 35 form a plurality of sustain electrode pairs. Bus electrodes 40 and 41 are formed on the display electrodes 34 and 35, respectively. The bus electrodes 40 and 41 are disposed to mitigate the greater electric resistances of the display electrodes 34 and 35 that are formed of a transparent material.

In one embodiment, igniter electrodes 36 and 37 are formed between the X and Y display electrodes 34 and 35 on the inner surface of the front substrate 31. In one embodiment, the same voltage as that of the X display electrode 34 is applied to the igniter electrode 36, and the same voltage as that of the Y display electrode 35 is applied to the igniter electrode 37. In this embodiment, the display electrodes 34, 35 and the igniter electrodes 36, 37 are connected to each other (although not shown on the drawings). For example, the X display electrode 34 can be connected to the first igniter electrode 36, and the Y display electrode 35 can be connected to the second igniter electrode 37. In one such connection embodiment, bridges, connecting the display electrodes 34, 35 and the igniter electrodes 36, 37 and formed of conductive material, can be formed on the inner surface of the front substrate 31.

In one embodiment, the discharge gaps between the display electrodes 34 and 35 can be widened in conjunction with use of the igniter electrodes 36 and 37 while maintaining a low discharge voltage, and accordingly, the discharge efficiency can be improved. Generally, since the discharge occurs more easily when the gap between the display electrodes 34 and 35 is small, the electrodes 34 and 35 can be located close with respect to each other in order to reduce the sustain discharge voltage and reduce the power consumption. However, as the distance between the display electrodes 34 and 35 narrows, moving paths of the wall charges are reduced, the volume of discharge space is reduced and the amount of light emission is also reduced, and thus, the discharge efficiency is degraded. In one embodiment, the igniter electrodes 36 and 37 are formed to solve the above problems. In this embodiment, the discharge occurs between the igniter electrodes 36 and 37 first, and then, the sustain discharge occurs between the display electrodes 36 and 37. Therefore, the igniter electrodes 36 and 37 increase the distance between the display electrodes 34 and 35, and at the same time, ensure that the sustain discharge occurs throughout the entire space between the display electrodes 34 and 35. According to this embodiment, an initial voltage of the sustain discharge can be reduced and the light emission efficiency can be enhanced.

In one embodiment, the display electrodes 34 and 35, the bus electrodes 40 and 41, and the igniter electrodes 36 and 37 are covered by a first dielectric layer 32. The first dielectric layer 32 is formed on the inner surface of the front substrate 31 to cover the above electrodes.

Also, in the embodiment, shown in FIG. 3, a first floating electrode 38 and a second floating electrode 39 may be formed on an inner surface of the first dielectric layer 32. In one embodiment, the floating electrodes 38 and 39 are formed adjacent to the end portions of the display electrodes 34 and 35 on the inner surface of the first dielectric layer 32. For example, the floating electrode 38 is formed on the first dielectric layer 32 corresponding to an end portion of the X display electrode 34, and the floating electrode 39 is formed on the first dielectric layer 32 corresponding to an end portion of the Y display electrode 35. The voltage is not applied to the floating electrodes 38 and 39. In one embodiment, the floating electrodes 38 and 39 change paths of the electric fields formed between the display electrodes 34 and 35, and make space charges collide with the discharge gas. As described above, when the possibility of collision between the space charges and the discharge gas increases by use of the floating electrodes 38 and 39, the discharge gas emits more ultraviolet radiation, and the light emission efficiency can be greatly improved.

In one embodiment, the floating electrodes 38 and 39 are covered by a second dielectric layer 33. The second dielectric layer 33 is formed on the first dielectric layer 32 to cover the second dielectric layer 33. In addition, an electric field concentration portion 33a is formed on the second dielectric layer 33. In one embodiment, the electric field concentration portion 33a is a recess where a portion of the second dielectric layer 33 is thinner than the remaining portion of the second dielectric layer 33. In one embodiment, the electric field concentration portion 33a is formed on a center portion of the discharge space defined between barrier ribs 48, and is formed on the position corresponding to the discharge gap defined between the display electrodes 34 and 35. Generally, the electric field becomes stronger at a thinner portion of a dielectric layer, and thus, a strong electric field can be generated at the electric field concentration portion 33a. The strong electric field can reduce the discharge voltage, and the amount of discharge gas of high partial pressure used. A protective layer 42 such as an MgO layer is formed on the inner surface of the second dielectric layer 33. The first and second floating electrodes 38 and 39 are disposed on both sides of the electric field concentration portion 33a.

On the inner surface of the rear substrate 45, address electrodes 47 and barrier ribs of general structure can be formed. In FIG. 3, the address electrodes 47 are formed on the rear substrate 45, and extend in a direction so as to cross the length directions of the display electrodes 34 and 35. The address electrodes 47 are covered by a rear dielectric layer 46 formed on the rear substrate 45. The barrier ribs 48 extending in the direction where the address electrodes 45 extend are formed on the rear dielectric layer 46. Phosphor layers 49 are formed on the rear dielectric layer 46 and between the barrier ribs 48. The address electrodes 47 are disposed directly below the discharge spaces formed between the barrier ribs 48.

In FIG.3, the barrier ribs 48 extend in parallel to each other, however, the barrier ribs 48 can be formed in other configurations. For example, the barrier ribs. 48 can be formed as a matrix having a first portion formed in the same direction where the address electrodes 47 extend, and a second portion crossing the first portion at the right angle. In this case, the discharge spaces are surrounded by the barrier ribs 48 with closed four sides, and the cross talk generating between neighboring discharge cells can be prevented.

In one embodiment, as shown in FIG. 3, the electric field concentration portion 33a extends in the entire length direction of the display electrodes 34 and 35 on the second dielectric layer 33 formed on the front substrate 31. In another embodiment, the electric field concentration portion 33a can be formed intermittently. For example, the electric field concentration portion 33a is not formed on the portions of the second dielectric layer 33, which are located directly above the barrier ribs 48. Instead, the electric field concentration portion 33a is formed on the portions of the second dielectric layer 33, which are located directly above the discharge spaces that are formed between the barrier ribs 48. Consequently, the electric field concentration portion 33a can be formed intermittently in the length direction of the display electrodes 34 and 35, as well as in the length direction of the address electrodes 47.

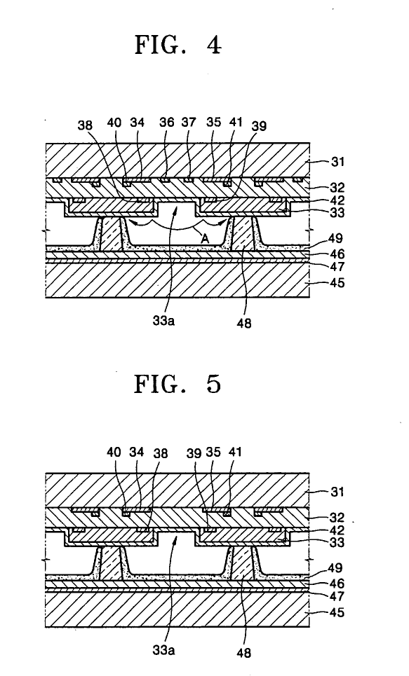

FIG. 4 is a schematic cross-sectional view of the plasma display panel of FIG. 3.

In one embodiment, as shown in FIG. 4, the igniter electrodes 36 and 37 are formed between the X and Y display electrodes 34, 35, and the second dielectric layer 33 is formed on the inner surface of the first dielectric layer 32. In addition, the electric field concentration portion 33a is formed on the second dielectric layer 33, and the floating electrodes 38 and 39 are formed on the inner surface of the first dielectric layer 32.

In the PDP having the above structure, the sustain discharge initially occurs between the igniter electrodes 36 and 37, and then, is diffused toward the center portions of the X and Y display electrodes 34 and 35 and the end portions thereof. At the same time, the sustain discharge occurs along an arrow A of FIG. 4, as well as along a direct path between the display electrodes 34 and 35. Therefore, the paths of the electric fields are changed, and the possibility of the discharge gas to collide with the space charges is increased. In addition, since the electric field concentration portion 33a is formed between the second dielectric layers 33, an even stronger electric field is formed.

FIG. 5 is a schematic cross-sectional view of a PDP according to another embodiment of the present invention. Basic structures of the PDP of FIG. 5 are similar to those of the panel shown in FIG. 4, and the same reference numerals denote the same elements. Detailed descriptions for the same elements will be omitted.

In this embodiment, the igniter electrodes 36, 37 are not formed between the display electrodes 34 and 35 in the plasma display panel of FIG. 5. However, the floating electrode 38, 39 and the electric field concentration portion 33a are formed on the plasma display panel of FIG. 5. Still, in this embodiment, the strong electric field can be formed and the possibility of the discharge gas to collide with the space charges is increased.

According to one embodiment of the present invention, the sustain discharge can occur with low voltage by forming the igniter electrodes between the display electrodes, and the discharge gap between the display electrodes can be increased. Therefore, the light emission efficiency of the plasma display panel can be improved. In addition, since the sustain discharge occurs with the low voltage, power consumption and the radiation of electromagnetic waves can be reduced.

While the above description has pointed out novel features of the invention as applied to various embodiments, the skilled person will understand that various omissions, substitutions, and changes in the form and details of the device or process illustrated may be made without departing from the scope of the invention. Therefore, the scope of the invention is defined by the appended claims rather than by the foregoing description. All variations coming within the meaning and range of equivalency of the claims are embraced within their scope.

What is claimed is:

1. A plasma display panel, comprising:
a front substrate and a rear substrate facing the front substrate;
X display electrodes and Y display electrodes formed on an inner surface of the front substrate in a first direction;
first igniter electrodes and second igniter electrodes formed between the X and Y display electrodes;
a first dielectric layer formed on the inner surface of the front substrate covering the X and Y display electrodes, and the first and second igniter electrodes;
first floating electrodes and second floating electrodes formed on an inner surface of the first dielectric layer in substantially the same direction as the first direction;
a second dielectric layer formed on the inner surface of the first dielectric layer covering the floating electrodes;
a protective layer formed on an inner surface of the second dielectric layer;
address electrodes formed on an inner surface of the rear substrate in a second direction substantially perpendicular to the first direction;
a rear dielectric layer covering the address electrodes;
barrier ribs formed on an upper surface of the rear dielectric layer to define discharge spaces;
phosphor layers formed in the discharge spaces; and
a discharge gas filled in the discharge spaces.

2. The plasma display panel of claim 1, wherein the second dielectric layer includes at least one electric field concentration portion which is thinner than the remaining portion of the second dielectric layer.

3. The plasma display panel of claim 2, wherein the at least one electric field concentration portion is disposed on the center of the discharge spaces defined between the barrier ribs, at the portions corresponding to the discharge gaps between the display electrodes.

4. The plasma display panel of claim 1, wherein the same voltage as that applied to the X display electrodes is applied to the first igniter electrodes, and the same voltage as that applied to the Y display electrodes is applied to the second igniter electrodes.

5. The plasma display panel of claim 1, wherein each X display electrode is connected to a respective first igniter electrode, and each Y display electrode is connected to a respective second igniter electrode.

6. The plasma display panel of claim 4, wherein each X display electrode is connected to a respective first igniter electrode, and each Y display electrode is connected to a respective second igniter electrode.

7. The plasma display panel of claim 1, wherein the voltage is not applied to the first and second floating electrodes;

8. The plasma display panel of claim 1, wherein the floating electrodes are formed on the portions corresponding to adjacent end portions of the X and Y display electrodes.

9. The plasma display panel of claim 2, wherein the first and second floating electrodes are disposed on both sides of the electric field concentration portion.

10. A plasma display panel, comprising:
a front substrate and a rear substrate facing the front substrate;
X display electrodes and Y display electrodes formed on an inner surface of the front substrate in a first direction;
a first dielectric layer formed on the inner surface of the front substrate covering the X and Y display electrodes, and the first and second igniter electrodes;
first floating electrodes and second floating electrodes formed on an inner surface of the first dielectric layer in substantially the same direction as the first direction;
a second dielectric layer formed on the inner surface of the first dielectric layer covering the floating electrodes, wherein the second dielectric layer includes at least one electric field concentration portion which is thinner than the remaining portion of the second dielectric layer;
a protective layer formed on an inner surface of the second dielectric layer;
address electrodes formed on an inner surface of the rear substrate in a second direction substantially perpendicular to the first direction;
a rear dielectric layer covering the address electrodes;
barrier ribs formed on an upper surface of the rear dielectric layer to define discharge spaces;
phosphor layers formed in the discharge spaces; and
a discharge gas filled in the discharge spaces.

11. The plasma display panel of claim 10, wherein the at least one electric field concentration portion is disposed on centers of the discharge spaces defined by the barrier ribs, on portions corresponding to the discharge gaps defined between the display electrodes.

12. The plasma display panel of claim 10, wherein the voltage is not applied to the first and second floating electrodes.

13. The plasma display panel of claim 10, wherein the first and second floating electrodes are disposed on both sides of the at least one electric field concentration portion.

14. A plasma display panel, comprising:
a first igniter electrode and a second igniter electrode located between a pair of display electrodes, wherein the igniter electrodes and the display electrodes are formed in a dielectric layer; and
a first floating electrode and a second floating electrode formed on a surface of the dielectric layer.

15. A plasma display panel, comprising:
a first dielectric layer covering a pair of display electrodes; and
a second dielectric layer formed on a surface of the first dielectric layer and covering a first floating electrode and a second floating electrode, wherein the second dielectric layer includes at least one electric field concentration portion which is thinner than the remaining portion of the second dielectric layer.

16. The plasma display panel of claim 15, wherein the first and second floating electrodes are configured to change paths of electrical field generated between the display electrodes.
